(19) United States
(12) Patent Application Publication
(10) Pub. No.: US 2026/0351621 A1
(43) Pub. Date: Nov. 5, 2026

(54) BATTERY CELL WITH VARIABLE THICKNESS CURRENT COLLECTORS

(71) Applicant: Schaeffler Technologies AG & Co. KG, Herzogenaurach (DE)

(72) Inventor: Victor NORWICH, Wooster, OH (US)

(21) Appl. No.: 19/738,320

(22) Filed: Jul. 10, 2026

Related U.S. Application Data
(62) Division of application No. 18/119,231, filed on Mar. 8, 2023, now Pat. No. 12,731,793.

(51) Int. Cl. H01M 4/70; H01M 50/46; H01M 50/463

(52) U.S. Cl. CPC H01M 4/70; H01M 50/46; H01M 50/463

(57) ABSTRACT

A battery cell includes an anode current collector, an anode material layer on the anode current collector, a cathode current collector, a cathode material layer on the cathode current collector, and a separator sandwiched between the anode material layer and the cathode material layer. Each of the anode current collector, the anode material layer, the cathode current collector, the cathode material layer and the separator including a first side edge. Each of the anode current collector, the anode material layer, the cathode current collector, the cathode material layer and the separator including a second side edge. The anode current collector and the cathode current collector each have a tapered shape, with the second side edge of the anode current collector being thicker than the first side edge of the anode current collector and the first side edge of the cathode current collector being thicker than the second side edge of the cathode current collector.

### TECHNICAL FIELD

The present disclosure relates generally to electric vehicle batteries and more specifically to current collectors for electric vehicle batteries.

### BACKGROUND

Battery cells for electric vehicle batteries use current collectors having a uniform thickness.

### SUMMARY

A battery cell includes an anode current collector, an anode material layer on the anode current collector, a cathode current collector, a cathode material layer on the cathode current collector, and a separator sandwiched between the anode material layer and the cathode material layer. Each of the anode current collector, the anode material layer, the cathode current collector, the cathode material layer and the separator including a first side edge. Each of the anode current collector, the anode material layer, the cathode current collector, the cathode material layer and the separator including a second side edge. The anode current collector and the cathode current collector each have a tapered shape, with the second side edge of the anode current collector being thicker than the first side edge of the anode current collector and the first side edge of the cathode current collector being thicker than the second side edge of the cathode current collector.

### BRIEF DESCRIPTION OF THE DRAWINGS

The present disclosure is described below by reference to the following drawings, in which:

FIG. 1 shows a battery cell according to the present disclosure; and

FIG. 2 shows one of the anode current collectors and one of the cathode current collectors of the battery cell shown in FIG. 1.

### DETAILED DESCRIPTION

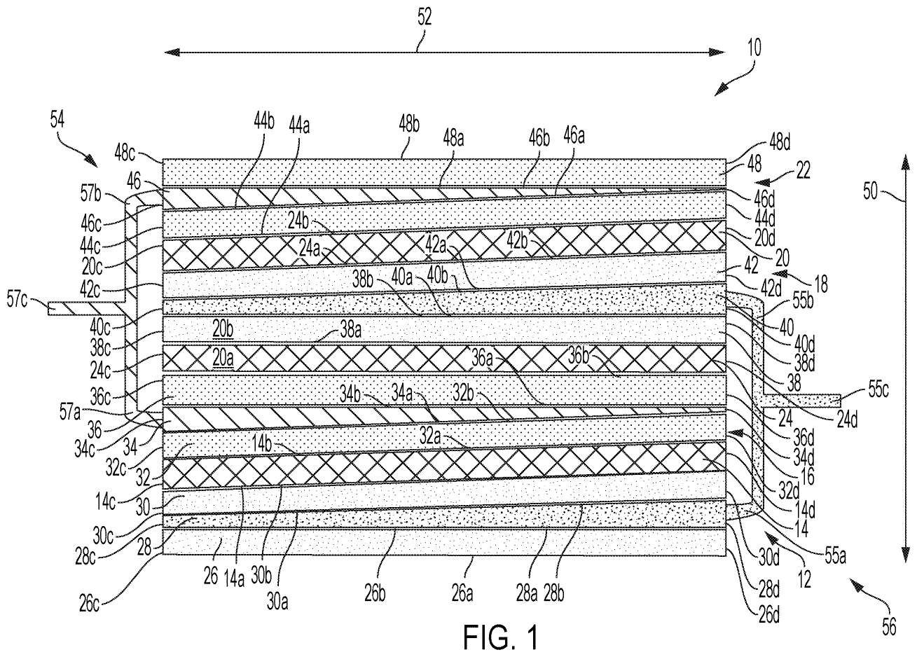

FIG. 1 shows a battery cell 10 including a first anode 12, a first separator 14, a first cathode 16, a second anode 18, a second separator 20, a second cathode 22 and a third separator 24.

The first anode 12 includes a first anode material layer 26, an anode current collector 28 and a second anode material layer 30. The first cathode 16 includes a first cathode material layer 32, a cathode current collector 34 and second cathode material layer 36. The second anode 18 includes a first anode material layer 38, an anode current collector 40 and a second anode material layer 42. The second cathode 22 includes a first cathode material layer 44, a cathode current collector 46 and second cathode material layer 48.

In order to allow battery cell 10 to have a decreased thickness in comparison with conventional battery assemblies including current collectors having uniform thicknesses, current collectors 28, 34, 40, 46 have a tapered shape. This arrangement can also advantageously generate less heat than current collectors having uniform thicknesses due to the terminal end being thicker and thus accommodating current flow in a manner that generates less heat, in comparison with a current collector having a uniform thickness and being of the same mass.

The first anode material layer 26 of first anode 12 includes a first planar surface 26a and a second planar surface 26b each extending between a first side edge 26c and a second side edge 26d of the first anode material layer 26. The first planar surface 26a and the second planar surface 26b face in opposite directions as each other and the first side edge 26c and the second side edge 26d face in opposite directions as each other. The anode current collector 28 includes a first planar surface 28a and a second planar surface 28b each extending between a first side edge 28c and a second side edge 28d of the anode current collector 28. The first planar surface 28a and the second planar surface 28b face in opposite directions as each other and the first side edge 28c and the second side edge 28d face in opposite directions as each other. The second anode material layer 30 includes a first planar surface 30a and a second planar surface 30b each extending between a first side edge 30c and a second side edge 30d of the second anode material layer 30. The first planar surface 30a and the second planar surface 30b face in opposite directions as each other and the first side edge 30c and the second side edge 30d face in opposite directions as each other.

The first cathode material layer 32 of first cathode 16 includes a first planar surface 32a and a second planar surface 32b each extending between a first side edge 32c and a second side edge 32d of the first cathode material layer 32. The first planar surface 32a and the second planar surface 32b face in opposite directions as each other and the first side edge 32c and the second side edge 32d face in opposite directions as each other. The cathode current collector 34 includes a first planar surface 34a and a second planar surface 34b each extending between a first side edge 34c and a second side edge 34d of the cathode current collector 34. The first planar surface 34a and the second planar surface 34b face in opposite directions as each other and the first side edge 34c and the second side edge 34d face in opposite directions as each other. The second cathode material layer 36 includes a first planar surface 36a and a second planar surface 36b each extending between a first side edge 36c and a second side edge 36d of the second cathode material layer 36. The first planar surface 36a and the second planar surface 36b face in opposite directions as each other and the first side edge 36c and the second side edge 36d face in opposite directions as each other.

The first anode material layer 38 of second anode 18 includes a first planar surface 38a and a second planar surface 38b each extending between a first side edge 38c and a second side edge 38d of the first anode material layer 38. The first planar surface 38a and the second planar surface 38b face in opposite directions as each other and the first side edge 38c and the second side edge 38d face in opposite directions as each other. The anode current collector 40 includes a first planar surface 40a and a second planar surface 40b each extending between a first side edge 40c and a second side edge 40d of the anode current collector 40. The first planar surface 40a and the second planar surface 40b face in opposite directions as each other and the first side edge 40c and the second side edge 40d face in opposite directions as each other. The second anode material layer 42 includes a first planar surface 42a and a second planar surface 42b each extending between a first side edge 42c and a second side edge 42d of the second anode material layer 42. The first planar surface 42a and the second planar surface 42b face in opposite directions as each other and the first side edge 42c and the second side edge 42d face in opposite directions as each other.

The first cathode material layer 44 of second cathode 22 includes a first planar surface 44a and a second planar surface 44b each extending between a first side edge 44c and a second side edge 44d of the first cathode material layer 44. The first planar surface 44a and the second planar surface 44b face in opposite directions as each other and the first side edge 44c and the second side edge 44d face in opposite directions as each other. The cathode current collector 46 includes a first planar surface 46a and a second planar surface 46b each extending between a first side edge 46c and a second side edge 46d of the cathode current collector 46. The first planar surface 46a and the second planar surface 46b face in opposite directions as each other and the first side edge 46c and the second side edge 46d face in opposite directions as each other. The second cathode material layer 48 includes a first planar surface 48a and a second planar surface 48b each extending between a first side edge 48c and a second side edge 48d of the second cathode material layer 48. The first planar surface 48a and the second planar surface 48b face in opposite directions as each other and the first side edge 48c and the second side edge 48d face in opposite directions as each other.

Anode material layers 26, 30, 38, 42 can each be a lithium metal. Lithium metals forming the anode material 26 can include lithium iron phosphate (LFP), lithium nickel cobalt aluminum oxide (NCA), lithium nickel manganese cobalt oxide (NMC), lithium cobalt oxide (LCO) and lithium manganese oxide (LMO).

Anode material layers 32, 36, 44, 48 can be lithium iron phosphate (LFP), lithium nickel cobalt aluminum oxide (NCA), lithium nickel manganese cobalt oxide (NMC), lithium cobalt oxide (LCO), lithium manganese oxide (LMO), lithium titanate (LTO), nickel cobalt aluminum oxide (NCA) or nickel cobalt manganese (NCM).

Anode current collectors 28, 40 can be formed of copper foil and cathode current collectors 34, 46 can be formed of aluminum foil.

Separators 14, 20, 24 can be saturated in a liquid electrolyte or can be a solid state electrolyte. Separator 14 includes a first planar surface 14a and a second planar surface 14b each extending between a first side edge 14c and a second side edge 14d. Separator 20 includes a first planar surface 20a and a second planar surface 20b each extending between a first side edge 20c and a second side edge 20d. Separator 24 includes a first planar surface 24a and a second planar surface 24b each extending between a first side edge 24c and a second side edge 24d.

Battery cell 10, as shown in FIG. 1, has a thickness 50 and a width 52. Battery cell 10 further includes a length extending into the page. Each of the layers of battery cell 10 also has a thickness, width and length, with the thickness being defined between the respective planar surfaces denoted in FIG. 1, and the width being defined between the respective side edges. For example, the length can be the same as the width for each layer, and the width and length of each layer is at least 4000 times the thickness. Thickness 50 of battery cell 10 is defined by first planar surface 26a of first anode material layer 26 and second planar surface 48b of second cathode material layer 48. Battery cell 10 has a uniform thickness. Width 52 is defined by a first side 54 and a second side 56 of battery cell 10. First side 54 is defined by the first side edges of the layers and second side 56 is defined by the second edges of the layers.

The anode current collectors 28, 40 and the cathode current collectors 34, 46 each have a tapered shape, with the second side edge 28d, 40d of each of the anode current collectors 28, 40 being thicker than the first side edge 28c, 40c of the respective anode current collectors 28, 40 and the second side edge 34d, 46d of each of the cathode current collectors 34, 46 being thicker than the first side edge 34a, 46a of the respective cathode current collector 34, 46. The thickness of anode current collectors 28, 40 continuously decreases while extending from the second side edge 28d, 40d to the first side edge 28c, 40c, and thickness of cathode current collectors 34, 46 continuously decreases while extending from the first side edge 34a, 46a to the second side edge 34d, 46d. In particular, current collectors 28, 34, 40, 46 each have a wedge shape, with the second planar surfaces 28b, 40c of the anode current collectors 28, 40 being inclined with respect to the respective planar 28a, 34a, 40a, 46a.

More specifically, the second planar surfaces 28b, 40c of the anode current collectors 28, 40 are at a non-zero angle with respect to the respective first planar surface 28a, 40a, and the first planar surfaces 34a, 46a of the cathode current collectors 34, 46 are at a non-zero angle with respect to the respective second planar surface 34b, 46b. In order to allow battery cell 10 to have a uniform thickness, the second planar surfaces 28b, 40c of the anode current collectors 28 face in opposite directions as the first planar surfaces 34a, 46a of the cathode current collectors 34, 46 and all of planar surfaces 28b, 40c, 34a, 46a have the same incline. The non-zero angle formed by the first planar surfaces 28a, 40a and second planar surfaces 28b, 40b of the anode current collectors 28, 40 and the non-zero angle formed by the first planar surfaces 34a, 46a and second planar surfaces 34b, 46b of the cathode current collector 34, 46 can each be a same angle.

Due to the incline of surfaces planar surfaces 28b, 40c, 34a, 46a of the current collectors 28, 40, 34, 46, the planar surfaces of second anode material layers 30, 42, first cathode layers 32, 44 and separators 14, 20 are also inclined (i.e., at a non-zero angle) with respect to the top electrode surface (planar surface 48b) and bottom electrode surface (planar surface 26a) of battery cell 10. As the top electrode surface and bottom electrode surface are also parallel to first planar surfaces 28a, 40a of anode current collectors 28, 40 and second planar surfaces 34b, 46b of cathode current collectors 34, 46, the planar surfaces of second anode material layers 30, 42, first cathode layers 32, 44 and separators 14, 20 are also inclined (i.e., at a non-zero angle) with respect to also inclined with respect to the first planar surfaces 28a, 40a of anode current collectors 28, 40 and second planar surfaces 34b, 46b of cathode current collectors 34, 46.

In particular, first planar surfaces 30a, 42a of anode material layers 30, 42, which contact respective second planar surfaces 28b, 40b of anode current collectors 28, 40, are inclined with respect to first planar surfaces 28a, 40a of anode current collectors 28, 40 and second planar surfaces 34b, 46b of cathode current collectors 34, 46, and are also inclined with respect to the top electrode surface (planar surface 48b) and bottom electrode surface (planar surface 26a) of battery cell 10. Second planar surfaces 30b, 42b of anode material layers 30, 42, which contact respective first planar surfaces 14a, 24a of separators 14, 20, are also inclined with respect to first planar surfaces 28a, 40a of anode current collectors 28, 40 and second planar surfaces 34b, 46b of cathode current collectors 34, 46, and are inclined with respect to the top electrode surface and bottom electrode surface of battery cell 10.

First planar surfaces 32a, 44a of cathode material layers 32, 44, which contact respective second planar surfaces 14b, 24b of separators 14, 20, are inclined with respect to first planar surfaces 28a, 40a of anode current collectors 28, 40 and second planar surfaces 34b, 46b of cathode current collectors 34, 46, and are also inclined with respect to the top electrode surface (planar surface 48b) and bottom electrode surface (planar surface 26a) of battery cell 10. Second planar surfaces 32b, 44b of cathode material layers 32, 44, which contact respective first planar surfaces 34a, 46a of cathode current collectors 34, 46, are also inclined with respect to first planar surfaces 28a, 40a of anode current collectors 28, 40 and second planar surfaces 34b, 46b of cathode current collectors 34, 46, and are also inclined with respect to the top electrode surface and bottom electrode surface of battery cell 10.

First planar surfaces 14a, 24a and second planar surfaces 14b, 24b of separators 14, 24 are inclined with respect to first planar surfaces 28a, 40a of anode current collectors 28, 40 and second planar surfaces 34b, 46b of cathode current collectors 34, 46, and are also inclined with respect to the top electrode surface (planar surface 48b) and bottom electrode surface (planar surface 26a) of battery cell 10.

In contrast, planar surfaces 26b, 38a, 38b of first anode material layers 26, 38, planar surfaces 36a, 36b, 48a of second cathode layers 36, 48 and the planar surfaces 24a, 24b of separator 24 are parallel to the top surface (planar surface 48b) and bottom surface (planar surface 26a) of battery cell 10, and are inclined with respect to the first planar surfaces 28a, 40a of anode current collectors 28, 40 and second planar surfaces 34b, 46b of cathode current collectors 34, 46.

Battery cell 10 further includes a first anode tab 55a extending from the second side edge 28d of the first anode current collector 28, a second anode tab 55b extending from the second side edge 40d of the second anode current collector 40, a first cathode tab 57a extending from the first side edge 34c of the first cathode current collector 34 and a second cathode tab 57b extending from the first side edge 46c of the second cathode current collector 46. The first anode tab 55a and the second anode tab 55b are joined together to form an anode terminal 55c and the cathode anode tab 57a and the second cathode tab 57b are joined together to form a cathode terminal 57c

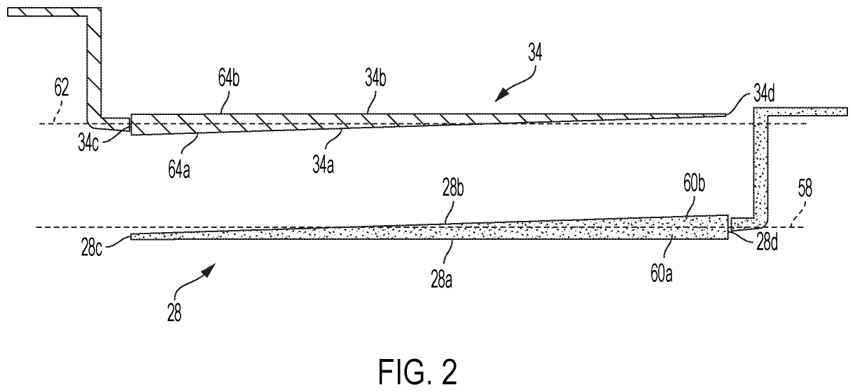

As illustrated in FIG. 2 by for example current collectors 28, 34, current collectors 28, 34, 40, 46 each have an asymmetrical thickness. The anode current collector 28 is intersected by a first plane 58 extending from midway the second side edge 28d and parallel to the first planar surface 28a of the anode current collector 28. The first plane 58 divides the anode current collector 28 into a first section 60a and a second section 60b. The first section 60a and the second section 60b are asymmetrical with respect to the first plane 58. Similarly, the cathode current collector 34 is intersected by a second plane 62 extending from midway the first side edge 34c and parallel to the second planar surface 34b of the cathode current collector 34. The second plane 62 divides the cathode current collector 34 into a first section 64a and a second section 64b. The first section 64a and the second section 64b of the cathode current collector 64 are asymmetrical with respect to the second plane 62.

Anode current collector 40 is configured in the same manner as anode current collector 28 and cathode current collector 46 is configured in the same manner as cathode current collector 34. Thus, the anode current collector 40 is intersected by a third plane extending from midway the second side edge 40d and parallel to the first planar surface 40a of the anode current collector 40, with the third plane dividing the anode current collector 40 into a first section and a second section that are asymmetrical with respect to the third plane. Also, the cathode current collector 46 is intersected by a fourth plane extending from midway the first side edge 46c and parallel to the second planar surface 46b of the cathode current collector 46, with the fourth plane dividing the cathode current collector 46 into a first section and a second section that are asymmetrical with respect to the fourth plane.

The first planar surface 28a of the anode current collector 28 is parallel to and facing away from the second planar surface 34b of the cathode current collector 34.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

### List of Reference Characters

10 battery cell
12 first anode
14 separators
14a first planar surface
14b second planar surface
14c first side edge
14d second side edge
16 first cathode
18 second anode
20 separators
20a first planar surface
20b second planar surface
20c first side edge
20d second side edge
22 second cathode
24 separators
24a first planar surface
24b second planar surface
24c first side edge
24d second side edge
26 first anode material layer
26a planar surface
26b second planar surface
26c first side edge
26d second side edge
28 anode current collectors
28a first planar surfaces
28b second planar surfaces
28c first side edge
28d second side edge
30 second anode material layer
30a first planar surface
30b second planar surface
30c first side edge
30d second side edge
32 first cathode material layer
32a first planar surface
32b second planar surface
32c first side edge
32d second side edge
34 cathode current collectors
34a first planar surfaces
34b second planar surfaces
34c first side edge
34d second side edge
36 second cathode material layer
36a first planar surface
36b second planar surface
36c first side edge
36d second side edge
38 first anode material layer
38a first planar surface
38b second planar surface
38c first side edge
38d second side edge
40 anode current collectors
40a first planar surfaces
40b second planar surface
40c first side edge
40d second side edge
42 second anode material layer
42a first planar surface
42b second planar surface
42c first side edge
42d second side edge
44 first cathode material layer
44a first planar surface
44b second planar surface
44c first side edge
44d second side edge
46 cathode current collectors
46a first planar surfaces
46b second planar surfaces
46c first side edge
46d second side edge
48 second cathode material layer
48a first planar surface
48b planar surface
48c first side edge
48d second side edge
50 thickness
52 width
54 first side
55a first anode tab
55b second anode tab
55c anode terminal
56 second side
57a first cathode tab
57b second cathode tab
57c cathode terminal
58 first plane
60a first section
60b second section
62 second plane
64 cathode current collector
64a first section
64b second section

What is claimed is:

1. A method of constructing a battery cell comprising:
stacking a plurality of layers together, the layers comprising:
an anode current collector including a first planar surface and a second planar surface each extending between a first side edge and a second side edge of the anode current collector;
a first anode material layer including a first planar surface and a second planar surface each extending between a first side edge and a second side edge of the first anode material layer;
a second anode material layer including a first planar surface and a second planar surface each extending between a first side edge and a second side edge of the second anode material layer;
a cathode current collector including a first planar surface and a second planar surface each extending between a first side edge and a second side edge of the cathode current collector;
a first cathode material layer including a first planar surface and a second planar surface each extending between a first side edge and a second side edge of the first cathode material layer;
a second cathode material layer including a first planar surface and a second planar surface each extending between a first side edge and a second side edge of the second cathode material layer; and
a separator,
the stacking being performed such that:
the separator is sandwiched between the second planar surface of the second anode material layer and the first planar surface of the first cathode material layer;
the second planar surface of the first anode material layer contacts the first planar surface of the anode current collector, the first planar surface of the second anode material layer contacts the second planar surface of the anode current collector, and the second planar surface of the first anode material layer extends at a non-zero angle with respect to the first planar surface of the second anode material layer; and
the second planar surface of the first cathode material layer contacts the first planar surface of the cathode current collector, the first planar surface of the second cathode material layer contacts the second planar surface of the cathode current collector, and the first planar surface of the second cathode material layer extends at a non-zero angle with respect to the second planar surface of the first cathode material layer.

2. The method as recited in claim 1 wherein the anode current collector and the cathode current collector each have a tapered shape, with the second side edge of the anode current collector being thicker than the first side edge of the anode current collector and the first side edge of the cathode current collector being thicker than the second side edge of the cathode current collector.

3. The method as recited in claim 2 wherein the stacking is performed such that the battery cell has a uniform thickness.

4. The method as recited in claim 1 wherein the separator includes a first side edge and a second side edge, and wherein the stacking is performed such that:
the first side edges of the anode current collector, the first anode material layer, the second anode material layer, the cathode current collector, the first cathode material layer, the second cathode material layer and the separator define a first side of the battery cell, and
the second side edges of the anode current collector, the first anode material layer, the second anode material layer, the cathode current collector, the first cathode material layer, the second cathode material layer and the separator define a second side of the battery cell.

5. The method as recited in claim 1 wherein the battery cell further comprises an anode tab extending from the first side edge of the anode current collector, and a cathode tab extending from the second side edge of the cathode current collector.

6. The method as recited in claim 1 wherein the stacking is performed such that:
the first planar surface of the anode current collector and the second planar surface of the cathode current collector face in opposite directions and are parallel to each other,
the second planar surface of the anode current collector is at a non-zero angle with respect to the first planar surface of the anode current collector,
the first planar surface of the cathode current collector is at a non-zero angle with respect to the second planar surface of the cathode current collector.

7. The method as recited in claim 6 wherein the non-zero angle formed by the first and second planar surfaces of the anode current collector and the non-zero angle formed by the first and second planar surfaces of the cathode current collector are equal to each other.

8. The method as recited in claim 6 wherein the first planar surface and the second planar surface of the second anode material layer face in opposite directions,
wherein the stacking is performed such that:
the first planar surface of the second anode material layer contacts the second planar surface of the anode current collector, and the first and second planar surfaces of the second anode material layer are at a non-zero angle with respect to the first planar surface of the anode current collector.

9. The method as recited in claim 8 wherein the first planar surface and the second planar surface extending of the first cathode material layer face in opposite directions,
wherein the stacking is performed such that:
the second planar surface of the first cathode material layer contacts the first planar surface of the cathode current collector, and the first and second planar surfaces of the first cathode material layer are at a non-zero angle with respect to the second planar surface of the cathode current collector.

10. The method as recited in claim 9 wherein the separator includes a first side edge, a second side edge, a first planar surface planar surface extending from the first side edge to the second side edge of the separator, and a second planar surface extending from the first side edge to the second side edge of the separator, the first planar surface and the second planar surface of the separator facing in opposite directions,
wherein the stacking is performed such that:
the first planar surface of the separator contacts the second planar surface of the second anode material layer, the second planar surface of the separator contacts the first planar surface of the first cathode material layer, and the first and second planar surfaces of the separator are at a non-zero angle with respect to the first planar surface of the anode current collector and to the second planar surface of the cathode current collector.

11. The method as recited in claim 6 wherein the battery cell further comprises an additional anode material layer on the first planar surface of the anode current collector,
the additional anode material layer including a first planar surface extending from a first side edge to a second side edge of the additional anode material layer and a second planar surface extending from the first side edge to the second side edge of the additional anode material layer, the first planar surface and the second planar surface of the additional anode material layer facing in opposite directions,
wherein the stacking is performed such that:
the first planar surface and the second planar surface of the additional anode material layer are parallel to the first planar surface of the anode current collector and the second planar surface of the cathode current collector.

12. The method as recited in claim 11 wherein the battery cell further comprises an additional cathode material layer on the second planar surface of the cathode current collector,
the additional cathode material layer including a first planar surface extending from a first side edge to a second side edge of the additional cathode material layer and a second planar surface extending from the first side edge to the second side edge of the additional cathode material layer, the first planar surface and the second planar surface of the additional cathode material layer facing in opposite directions,
wherein the stacking is performed such that:
the first planar surface and the second planar surface of the additional cathode material layer are parallel to the first planar surface of the anode current collector and the second planar surface of the cathode current collector.

13. The method as recited in claim 1 wherein the stacking is performed such that:
the anode current collector is intersected by a first plane extending from midway the second side edge of the anode current collector and parallel to the first planar surface of the anode current collector, the first plane dividing the anode current collector into a first section and a second section, the first section and the second section of the anode current collector being asymmetrical with respect to the first plane, and
the cathode current collector is intersected by a second plane extending from midway the first side edge of the cathode current collector and parallel to the second planar surface of the cathode current collector, the second plane dividing the cathode current collector into a first section and a second section, the first section and the second section of the cathode current collector being asymmetrical with respect to the second plane.

14. The method as recited in claim 13 wherein the stacking is performed such that:
the first planar surface of the anode current collector is parallel to and facing away from the second planar surface of the cathode current collector.

15. The method as recited in claim 13 wherein the anode current collector, the first anode material layer and the second anode material layer form a first anode, the cathode current collector, the first cathode material layer and the second cathode material layer form a first cathode, and the battery cell further includes:
a second anode including an anode current collector, a first anode material layer and a second anode material layer;
a second cathode including a cathode current collector, a first cathode material layer and a second cathode material layer; and
a second separator between the second anode and the second cathode configured to enable a transfer of ions between the second anode and the second cathode,
the anode current collector of the second anode including a first side edge, a second side edge opposite of the first side edge, a first planar surface extending from the first side edge to the second side edge, and a second planar surface opposite of the first planar surface extending from the first side edge to the second side edge;
the cathode current collector of the second cathode including a first side edge, a second side edge opposite of the first side edge, a first planar surface extending from the first side edge to the second side edge, and a second planar surface opposite of the first planar surface extending from the first side edge to the second side edge,
wherein the stacking is performed such that:
the anode current collector of the second anode is intersected by a third plane extending from midway the second side edge of the anode current collector of the second anode and parallel to the second planar surface of the anode current collector of the second anode, the third plane dividing the anode current collector of the second anode into a first section and a second section, the first section and the second section of the anode current collector of the second anode being asymmetrical with respect to the third plane, and
the cathode current collector of the second cathode is intersected by a fourth plane extending from midway the first side edge of the cathode current collector of the second cathode and parallel to the second planar surface of the cathode current collector of the second cathode, the fourth plane dividing the cathode current collector of the second cathode into a first section and a second section, the first section and the second section of the cathode current collector of the second cathode being asymmetrical with respect to the fourth plane.

16. The method as recited in claim 15 wherein the anode current collector of the first anode includes a first anode tab extending from the first side edge of the anode current collector of the first anode, the anode current collector of the second anode including a second anode tab extending from the first side edge of the anode current collector of the second anode, the method further comprising joining the first anode tab and the second anode tab together to form an anode terminal,
wherein the cathode current collector of the first cathode includes a first cathode tab extending from the first side edge of the cathode current collector of the first cathode, the cathode current collector of the second cathode including a second cathode tab extending from the first side edge of the cathode current collector of the second cathode, the method further comprising joining the first cathode tab and the second cathode tab together to form a cathode terminal.

17. The method as recited in claim 15 wherein the battery cell further comprises a third separator, the stacking including sandwiching the third separator between the second planar surface of the anode current collector of the first anode and the first planar surface of the cathode current collector of the second cathode.

18. The method as recited in claim 13 wherein the second planar surface of the anode current collector is at a non-zero angle with respect to the first planar surface of the anode current collector,
the first planar surface of the cathode current collector being at a non-zero angle with respect to the second planar surface of the cathode current collector.
